(19) United States
(12) Patent Application Publication
(10) Pub. No.: US 2006/0119323 A1
(43) Pub. Date: Jun. 8, 2006

(54) Temperature responsive charging control circuit

(76) Inventor: Don Reed, Independence, MO (US)

Correspondence Address: Hovey Williams LLP;Suite 4001, 2405 Grand Blvd., Kansas City, MO, 64108, US

(21) Appl. No.: 11/004,476

(22) Filed: Dec. 3, 2004

(51) Int. Cl. H02J 7/00

(52) U.S. Cl. 320/150

(57) ABSTRACT

A passive, inexpensive, and simple temperature responsive charging control circuit (10) which permits maximum charging of a rechargeable battery (14) while preventing overheating of the battery. The charging control circuit is configured for use with a solar collector (12) that charges the battery and comprises a thermistor (50) interposed between the solar collector and the rechargeable battery. The thermistor exhibits low resistance when it is cool to provide nearly unrestricted charging of the battery and then progressively increases in resistance as it heats up to restrict the amount of battery charging. This provides maximum battery charging in the morning and other cool conditions while preventing overheating and resultant battery damage as ambient temperatures and/or internally-generated heat increases from a high charging rate.

### BACKGROUND OF THE INVENTION

1. Field of the Invention

The present invention relates to rechargeable batteries and solar-powered devices. More particularly, the invention relates to a temperature responsive charging control circuit for a solar-charged battery that permits maximum charging of the battery during low ambient light and/or cool conditions but limits charging of the battery during high ambient light and/or hot conditions.

2. Description of the Prior Art

Many electrical devices are powered by rechargeable batteries which are in turn charged by renewable energy sources. For example, yard signs, landscaping lights, street lights, remote telemetry sensors, and other similar loads are often powered by batteries charged with solar collectors. This eliminates energy costs and permits the devices to be placed nearly anywhere without regard to the availability of conventional power wiring.

However, unlike conventionally-powered devices, solar-powered devices must account for periods of time in which no additional electricity is available. The solar collectors, batteries and charging circuits for solar-powered devices therefore must be designed for maximum battery charging during daylight hours so as to provide sufficient power to the devices at night and on cloudy days.

The solar collectors, batteries, and charging circuits must also be designed to prevent overheating of the batteries. Those skilled in the art will appreciate that batteries in general, and rechargeable batteries in particular, are adversely affected by excess heat. When exposed to high temperatures for long periods of time, batteries quickly lose their ability to retain and discharge current. Such overheating can be caused by high ambient temperatures during hot, sunny days and internally-generated heat created by current flowing to the battery and other electronic components.

The goals of maximum battery charging and prevention of overheating are somewhat at odds because maximum charging can cause overheating and heat avoidance limits the amount of possible charging. For example, one prior art method of preventing battery overheating is to use a smaller solar collector. Although this reduces the current supplied to the battery and, therefore, reduces overheating caused by overcharging, it also often results in insufficient battery charging. Solar-powered yard signs with small solar collectors often deplete their battery storage capabilities a few hours after dusk and are especially ineffective in northern climates and when positioned in shaded areas.

One prior art solution to prevent battery overheating while permitting maximum battery charging is to use an electronic voltage regulator circuit to measure and limit the amount of current delivered to the battery. Unfortunately, such electronic voltage regulator circuits are too expensive and complex for many applications such as yard signs and landscaping lights.

Another prior art solution to battery overheating is to provide a fan or other active cooling device for removing heat from the battery and other electronic components. However, as with electronic voltage regulators, use of fans and other cooling devices is not practical for low cost applications such as yard signs. Moreover, fans and other active cooling devices use electricity themselves, necessitating larger solar collectors and batteries and thus compounding the very same overheating problem they are supposed to alleviate.

### SUMMARY OF THE INVENTION

The present invention solves the above-described problems and provides a distinct advance in the art of rechargeable batteries. More particularly, the invention provides a passive, inexpensive, and simple temperature responsive charging control circuit which permits maximum charging of a rechargeable battery while preventing overheating of the battery.

In one embodiment of the present invention, the charging control circuit is configured for use with a solar collector that charges a rechargeable battery. The charging control circuit comprises a thermistor interposed between the solar collector and the rechargeable battery. The thermistor exhibits low resistance when it is cool to provide nearly unrestricted charging of the battery and then progressively increases in resistance as it heats up to restrict the amount of battery charging. This provides maximum battery charging in the morning and other cool conditions while preventing overheating and resultant battery damage as ambient temperatures and/or internally-generated heat increases.

The particular size of the thermistor is selected to match the operating parameters of the solar cell and battery so that the charging control circuit can be used with nearly any battery-powered electrical load. The preferred thermistor is a commercially available Polyswitch brand resettable fuse, but it is used in such a way in the present invention that it never carries sufficient current to reach its trip rating.

To enhance the operation of the charging control circuit, the thermistor may be wholly or partially covered by insulating tape or some other insulation to retain self-generated heat caused by current flow through the thermistor. This causes the internal resistance of the thermistor to increase more rapidly to more quickly limit charging of the battery as ambient and/or internally-generated temperatures rise.

The charging control circuit of the present invention may be used with any power source, but is particularly suitable for use with renewable-energy power sources, such as solar collectors, wind turbines, geothermal generators, and hydro-generators. Similarly, the charging control circuit and the batteries charged thereby may power any electrical load, but are particularly suitable for electrical loads with low energy demands, such as yard signs, landscaping lights, street lights, and remote telemetry sensors.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a block diagram of a temperature responsive charging control circuit constructed in accordance with a preferred embodiment of the present invention and shown coupled with a power source, a rechargeable battery, and an electrical load.

FIG. 2 is a circuit diagram illustrating in more detail the temperature responsive charging control circuit, the power source, the rechargeable battery, and an exemplary load.

FIG. 3 is a perspective view of a solar-powered yard sign, an example of a load that may be used with the temperature responsive charging control circuit.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

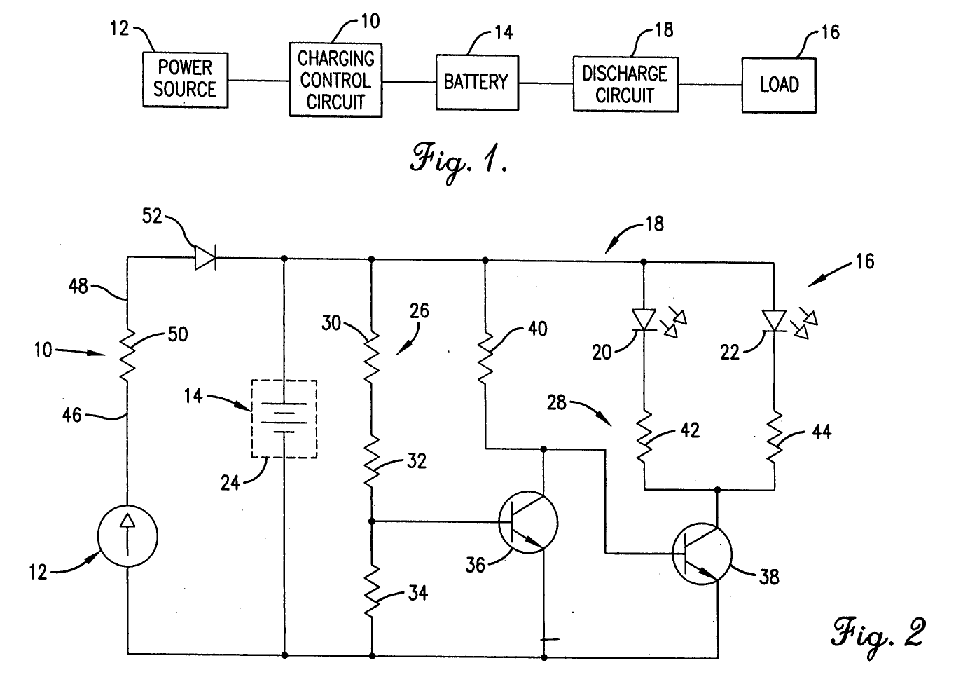

Turning now to the drawing figures, and particularly FIG. 1, a temperature responsive charging control circuit 10 constructed in accordance with a preferred embodiment of the present invention is illustrated. The charging control circuit 10 is shown interposed between a power source 12 and a rechargeable battery 14 that is used to power an electrical load 16. A battery discharge control circuit 18 is interposed between the battery 14 and the load 16 for controlling discharge of the battery 14. The circuit diagram of FIG. 2 illustrates the interconnection of these components, all of which are discussed in more detail below.

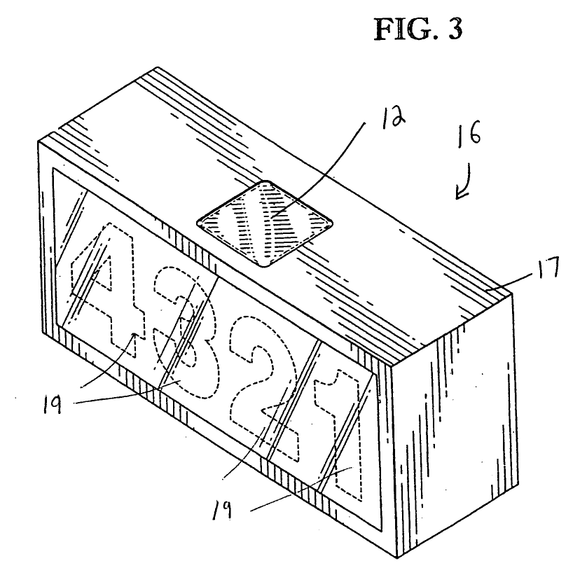

The charging control circuit 10 may be used in nearly any application with nearly any electrical load 16. However, the charging control circuit 10 is particularly suited for use with relatively inexpensive electrical devices with low energy demands such as solar-powered yard signs, landscaping lights, street lights, and remote telemetry sensors. For purposes of describing a preferred embodiment of the present invention, the load 16 will be hereinafter described as being an illuminated yard sign such as the one illustrated in FIG. 3. The yard sign may be used to display a homeowner's address or other information and includes a housing 17, a plurality of numbers 19, letters or other address indicators formed of opaque or translucent material on a transparent or translucent panel positioned optimally at a front face of the housing 17, and one or more internal light sources 20, 22 shown in FIG. 2 for illuminating the numbers 19 so the address or other information on the yard sign can be more easily viewed at night. The preferred light sources are light emitting diodes (LEDs) each rated for up to 20 mA. The size, shape, and configuration of the yard sign 16 can be varied as a matter of design choice. The particular yard sign 16 illustrated in FIG. 3 is provided as an example only.

The power source 12 may be any device capable of delivering electrical current through the charging control circuit 10 and to the battery 14 and the load 16. However, the charging control circuit 10 is particularly suited for use with renewable energy power sources such as a solar collector, wind turbine, geothermal generator, or a hydro-powered generator. For purposes of disclosing a preferred embodiment of the invention, the power source 12 will be hereinafter described as being a solar collector configured for powering the yard sign 16 described above.

The solar collector 12 is sized to correspond to the operating parameters of the battery 14, charging control circuit 10, and the load 16. For the exemplary yard sign application, the solar collector 12 is configured to deliver approximately 0.35 Amps of current when exposed to direct summer sunlight. To provide maximum battery charging capabilities, the solar collector 12 is preferably positioned in or on the top of the yard sign 16 housing 17 as illustrated in FIG. 3 and is installed so as to be exposed to a maximum amount of sunlight available in the location in which the yard sign 16 is placed.

The rechargeable battery 14 may be any type of conventional battery or grouping of batteries that can be charged and recharged by the solar collector 12. For the exemplary yard sign application, the battery preferably consists of two NiCAD AA sized batteries in series that are each rated at 1.35 Volts and 900 mAHr. The batteries are preferably removably positioned within a conventional battery holder assembly 24 which is wired or otherwise connected to the charging control circuit 10, the yard sign load 16 and the battery discharge circuit 18 as shown in FIG. 2.

The battery discharge control circuit 18 is wired or otherwise connected between the battery 14 and the electrical load 16 and is operable for: 1) controlling the amount of current delivered from the battery 14 to the load 16, and 2) preventing excessive battery discharge. To these ends, the battery discharge control circuit includes a daylight sensor 26 and a battery drain resistor drain circuit 28.

The daylight sensor 26 permits delivery of current from the rechargeable battery 14 to the LEDs 16 at night or during other low ambient light conditions and prevents delivery of current from the rechargeable battery 14 to the load 16 during the daytime or other high ambient light conditions. The preferred daylight sensor 26 comprises a light variable resistor 30 and two series-connected conventional resistors 32, 34 all wired in parallel between the battery 14 and the LEDs 16. The light variable resistor 30 is preferably a cadmium sulfide-type resistor having a rating of less than 1 k Ohm to more than 1 m Ohm. The resistors 32, 34 are preferably rated at 20 k Ohm and 10 k Ohm, respectively. The resistance of the light variable resistor 30 decreases when it is exposed to sunlight to limit the amount of current delivered to the LEDs 16. Conversely, the resistance of the light variable resistor 30 increases when it is exposed to less ambient light to direct more current to the LEDs 16. Thus, the LEDs 16 receive maximum current at night and other times when the light variable resistor 30 is exposed to the lowest level of ambient light and receive essentially no current when the light variable resistor 30 is exposed to full sunlight.

The battery drain circuit 28 permits delivery of current from the battery 14 to the LEDs 16. When the battery 14 is discharged below the LED voltage threshold, the LEDs prevent further battery discharge and resultant battery damage. The battery drain circuit 28 consists of two NPN transistors 36, 38 and two resistors 42, 44. For the exemplary yard sign application, the transistors 36, 38 are each rated with a gain of 40, the resistor 40 is rated 6.8 k Ohm, and the resistors 42, 44 are each rated 68 Ohm so as to set the maximum discharge of the battery 14.

In accordance with one aspect of the present invention, the charging control circuit 10 is wired or otherwise connected between the power source 12 and the battery 14 and is provided for maximizing battery charging while preventing battery overheating. For the solar-powered yard sign application described above, the charging control circuit 10 permits maximum charging of the battery during low ambient light and/or cool conditions, but limits charging of the battery during high ambient light and/or hot conditions.

The charging control circuit 10 broadly includes a conductor 46 coupled with the power source 12, a conductor 48 coupled with the battery 14 or the battery holder assembly 24, and a single, passive electrical component 50 interposed between the power source conductor 46 and the battery conductor 48. A diode 52 may be wired or otherwise connected between the component 50 and the battery 14 to prevent reverse current from flowing from the battery 14 to the solar collector 12 during periods of no illumination. The component 50 is operable to reduce current flow to the battery or battery holder assembly as the component is subjected to increasing temperatures.

In preferred forms, the component 50 is a positive temperature thermistor. The thermistor exhibits low resistance when it is cool to provide nearly unrestricted charging of the battery 14 and then progressively increases in resistance as it heats up to restrict the amount of battery charging. This provides maximum battery charging in the morning and other cool conditions while preventing overheating and resultant battery damage as ambient temperatures and/or internally-generated heat of the component 50 or the battery 14 itself increases.

The particular type, size, and rating of the thermistor 50 is selected to match the operating parameters of the solar cell 12 and battery 14 so that the charging control circuit 10 can be used with nearly any battery-powered electrical load. For the yard sign application described above, the preferred thermistor 50 is a Raychem MINISMD series stock number C014 Polyswitch brand resettable fuse having a minimum resistance of 1.50 Ohms, to 6 Ohms, a maximum voltage of 60 volts, a maximum current of 10 amps, a hold current of 0.14 amps, and a trip current of 0.34 amps. Although the preferred thermistor 50 can act as a resettable fuse, it cooperates with the solar collector 12 and battery 14 so that it never carries sufficient current to trip. Specifically, the size and ratings of the solar collector 10, battery 14, and thermistor 50 cooperate to prevent the thermistor from carrying current in excess of 0.34 amps, the trip rating of the thermistor.

To enhance the operation of the charging control circuit 10, the thermistor 50 may be wholly or partially covered by insulating tape or some other insulation to retain self-generated heat caused by the battery charging current flow through the thermistor. This causes the internal resistance of the thermistor 50 to increase more rapidly to more quickly limit charging of the battery 14 as ambient and/or internally-generated temperatures rise. The insulating tape serves as an optional “tuning” device and may or may not be needed based on the size and rating of the other components. For example, if a larger solar collector is used, the insulating tape may not be needed as the larger solar collected would deliver sufficient current through the thermistor 50 to increase its temperature without the insulation.

Although the invention has been described with reference to the preferred embodiment illustrated in the attached drawing figures, it is noted that equivalents may be employed and substitutions made herein without departing from the scope of the invention as recited in the claims. For example, although the present invention is described and illustrated as being particularly suited for use with a solar-powered yard sign, it may be used equally well with other electrical loads. Moreover, the specific values and ratings of the components described herein are provided only for purposes of describing a best mode of the invention and may be varied without departing from the scope of the invention.

Having thus described the preferred embodiment of the invention, what is claimed as new and desired to be protected by Letters Patent includes the following:

1. A charging control circuit for a rechargeable battery, the circuit comprising:
a conductor configured for coupling with a power source;
a conductor configured for coupling with the rechargeable battery; and
a thermistor interposed between the power source conductor and the battery conductor for reducing current flow to the battery conductor as the thermistor is subjected to increasing temperatures.

2. The circuit as set forth in claim 1, wherein the thermistor is a positive temperature thermistor.

3. The circuit as set forth in claim 1, wherein the power source is selected from the group consisting of a solar collector, a wind turbine, a geothermal generator, and a hydro-generator.

4. The circuit as set forth in claim 1, wherein the thermistor is subjected to the increasing temperatures because of increasing ambient temperatures.

5. The circuit as set forth in claim 1, wherein the thermistor is subjected to the increasing temperatures because of current flow from the power source conductor.

6. The circuit as set forth in claim 5, further including an insulator positioned at least partially over the thermistor to retain heat in the thermistor to more quickly reduce current flow to the battery conductor.

7. The circuit as set forth in claim 1, wherein the rechargeable battery powers an electrical load selected from the group consisting of a yard sign, a landscape light, a pool light, a street light, a remote telemetry sensor, a transceiver, and an electrical motor.

8. A charging control circuit for a rechargeable battery, the circuit comprising:
a conductor configured for coupling with a power source;
a conductor configured for coupling with a battery holder for the rechargeable battery; and
a single, passive electrical component interposed between the power source conductor and the battery holder conductor for reducing current flow to the battery holder conductor as the component is subjected to increasing temperatures.

9. The circuit as set forth in claim 8, wherein the single, passive electrical component is a thermistor.

10. The circuit as set forth in claim 9, wherein the thermistor is a positive temperature thermistor.

11. The circuit as set forth in claim 8, wherein the power source is selected from the group consisting of a solar collector, a wind turbine, a geothermal generator, and a hydro-generator.

12. A power source for an electrical load, the power source comprising:
a solar collector;
a rechargeable battery; and
a thermistor interposed between the solar collector and the rechargeable battery for reducing current flow from the solar collector to the rechargeable battery as the thermistor is subjected to increasing temperatures.

13. The power source as set forth in claim 12, further including a battery discharge control circuit interposed between the rechargeable battery and the electrical load.

14. The power source as set forth in claim 13, wherein the battery discharge control circuit includes a daylight sensor that permits delivery of current from the rechargeable battery to the load during low ambient light conditions and resists delivery of current from the rechargeable battery to the load during high ambient light conditions.

15. The power source as set forth in claim 13, wherein the battery discharge control circuit includes a battery drain circuit that permits delivery of current from the rechargeable battery to the load when the rechargeable battery is charged above a threshold level.

16. The power source as set forth in claim 15, wherein the load prevents delivery of current from the rechargeable battery to the load when the battery is charged below the load's threshold level.

17. The power source as set forth in claim 12, further including an insulator positioned at least partially over the thermistor to retain heat in the thermistor to more quickly reduce current flow to the rechargeable battery as the thermistor is subjected to increasing temperatures.

18. A power source for an electrical load, the power source comprising:
a solar collector;
a rechargeable battery; and
a single, passive electrical component interposed between the solar collector and the rechargeable battery for reducing current flow from the solar collector to the rechargeable battery as the component is subjected to increasing temperatures.

19. The power source as set forth in claim 18, wherein the single, passive electrical component is a thermistor.

20. The power source as set forth in claim 19, wherein the thermistor is a positive temperature thermistor.

21. The power source as set forth in claim 18, further including a battery discharge control circuit interposed between the rechargeable battery and the electrical load.

22. The power source as set forth in claim 21, wherein the battery discharge control circuit includes a daylight sensor that permits delivery of current from the rechargeable battery to the load during low ambient light conditions and resists delivery of current from the rechargeable battery to the load during high ambient light conditions.

23. The power source as set forth in claim 21, wherein the battery discharge control circuit includes a battery drain circuit that permits delivery of current from the rechargeable battery to the load when the rechargeable battery is charged above a threshold level.

24. The power source as set forth in claim 23, wherein the load prevents delivery of current from the rechargeable battery to the load when the battery is charged below the load's threshold level.
